(19) United States
(12) Patent Application Publication
(10) Pub. No.: US 2013/0049510 A1
(43) Pub. Date: Feb. 28, 2013

(54) MOTOR FOR A VEHICLE SEAT

(71) Applicants: Kwang Ho Choi, Gwangju (KR); Bumre Roh, Gimhae-si (KR)

(72) Inventors: Kwang Ho Choi, Gwangju (KR); Bumre Roh, Gimhae-si (KR)

(73) Assignee: B.M.C Co., Ltd., Anseong-si (KR)

(21) Appl. No.: 13/641,257

(22) PCT Filed: Apr. 15, 2011
(86) PCT No.: PCT/KR11/02696

§ 371 Date: Oct. 25, 2012

(30) Foreign Application Priority Data
Apr. 15, 2010 (KR) 10-2010-0034837

(51) Int. Cl. H02K 23/04

(52) U.S. Cl. 310/154.01

(57) ABSTRACT

The present invention relates to automobile seat motor including: a motor housing having a first flux ring coupling portion formed at the inside of the front side thereof; a first flux ring coupled to the first flux ring coupling portion and having a ring magnet coupled to the inside thereof; a motor shaft located at the center of the first flux ring coupling portion in such a manner as to be coupled rotatably to the motor housing; and a rotor located at the center of the inside of the ring magnet in such a manner as to be rotated together with the motor shaft.

### TECHNICAL FIELD

The present invention relates to motors, and more particularly, to a motor for an electric component of an automobile like an automobile seat, while having a new magnetic field structure.

### BACKGROUND ART

Generally, a back rest of an automobile seat is adjusted or changed in position through an electrical operation of a motor, and the automobile seat is called an electric seat or a power seat. Further, the motor used for the automobile seat is called a seat motor. Structures of conventional seat motors have been disclosed in Korean Patent No. 10-0851884 and Japanese Patent No.4275039. FIG. 1 is an exploded perspective view showing one of the conventional seat motors.

Referring to FIG. 1, the conventional seat motor largely includes a yoke 100, a motor housing 200, an amateur 300 and a gear 400. The yoke 100 has a steel yoke housing 101 having a magnet 104 attached to the inside thereof and a shaft coupling portion 103 formed on the center of the front portion thereof in such a manner as to be coupled to a motor shaft 50. The amateur 300 to which the motor shaft 50 is coupled is inserted into the interior of the yoke housing 101 in such a manner as to be rotated together with the motor shaft 50, and the yoke housing 101 is fastened to the motor housing 200 by means of bolts 102. The amateur 300 has a rotor 302 around which coils are wound and a commutator 301 coupled to the rear portion of the rotor 302, and the commutator 301 is coupled rotatably to the interior of a brush holder 310. Thus, the amateur 300 is rotated through the magnetic operation with the magnet 104 disposed at the inside of the yoke housing 101 according to the variation of the magnetic flux, thereby causing the rotation of the motor shaft 50.

The motor housing 200 has a brush holder coupling portion 201 formed on the front side thereof, and the commutator 301 of the amateur 300 is rotatably located in the brush holder coupling portion 201. The rotary force of the motor shaft 50 is transmitted to the gear 400, thereby activating the back rest of the automobile seat.

Since the conventional seat motor has the magnetic field structure through the yoke housing 101 made of steel, it has a heavy weight, and further, since the coupling process between the yoke housing 101 and the motor housing 200 is needed, the assembling work may be complicated. Furthermore, the yoke housing 101 provided separately is coupled to the motor housing 200, which undesirably increases the whole volume of the seat motor.

According to recent automobile-related technology trends, hybrid automobiles or electric automobiles have been proposed and developed. That is, each part of the automobile becomes light and small, thereby enhancing the energy efficiency thereof. In case of the conventional seat motors, however, they are heavy and bulky, which does not match the recent technology trends.

According to the trends of light weight and miniaturization of the seat motor, therefore, the inventors of this invention have proposed a new automobile seat motor which is lighter and smaller than the conventional seat motor, while being easily assembled.

### DISCLOSURE

### [Technical Problem]

Accordingly, the present invention has been made in view of the above-mentioned problems occurring in the prior art, and it is an object of the present invention to provide an automobile seat motor that is capable of being light and small.

It is another object of the present invention to provide an automobile seat motor that is capable of being easily assembled.

### [Technical Solution]

To accomplish the above objects, according to a first aspect of the present invention, there is provided an automobile seat motor including: a motor housing having a first flux ring coupling portion formed at the inside of the front side thereof; a first flux ring coupled to the first flux ring coupling portion and having a ring magnet coupled to the inside thereof; a motor shaft located at the center of the first flux ring coupling portion in such a manner as to be coupled rotatably to the motor housing; and a rotor located at the center of the inside of the ring magnet in such a manner as to be rotated together with the motor shaft.

According to the present invention, preferably, the automobile seat motor further includes a commutator coupled to the front side of the rotor in such a manner as to be rotated together with the motor shaft.

According to the present invention, preferably, the automobile seat motor further includes: a brush holder into which the front side of the commutator is located; and an end cap having a brush holder coupling portion to which the brush holder is coupled formed at the inside thereof and a motor shaft coupling portion to which the motor shaft is coupled rotatably.

To accomplish the above objects, according to a second aspect of the present invention, there is provided an automobile seat motor including: a motor housing having a second flux ring coupling portion formed at the inside of the front side thereof; a second flux ring coupled to the second flux ring coupling portion and having a pair of segment magnets coupled to the inner surfaces of the top and bottom portions thereof; a motor shaft located at the center of the second flux ring coupling portion in such a manner as to be coupled rotatably to the motor housing; and a rotor located at the center of the inside of the pair of segment magnets in such a manner as to be rotated together with the motor shaft.

According to the present invention, preferably, the automobile seat motor further includes a commutator coupled to the front side of the rotor in such a manner as to be rotated together with the motor shaft.

According to the present invention, preferably, the automobile seat motor further includes: a brush holder into which the front side of the commutator is located; and an end cap having a brush holder coupling portion to which the brush holder is coupled formed at the inside thereof and a motor shaft coupling portion to which the motor shaft is coupled rotatably.

### [Advantageous Effects]

According to the present invention, the automobile seat motor has a motor housing having a new structure, thereby being light and small and easily assembled.

The above and other objects, features and advantages of the present invention will be apparent from the following detailed description of the preferred embodiments of the invention in conjunction with the accompanying drawings.

### DESCRIPTION OF DRAWINGS

FIG. 1 is an exploded perspective view showing a conventional seat motor.

FIG. 2 is an exploded perspective view showing an automobile seat motor according to a first embodiment of the present invention.

FIG. 3 is a schematic sectional view taken along the direction A-A′ of FIG. 2.

FIG. 4 is an exploded perspective view showing an automobile seat motor according to a second embodiment of the present invention.

FIG. 5 is a schematic sectional view taken along the direction B-B′ of FIG. 4.

### BEST MODE FOR INVENTION

Hereinafter, an explanation on an automobile seat motor according to preferred embodiments of the present invention will be given with reference to the attached drawings.

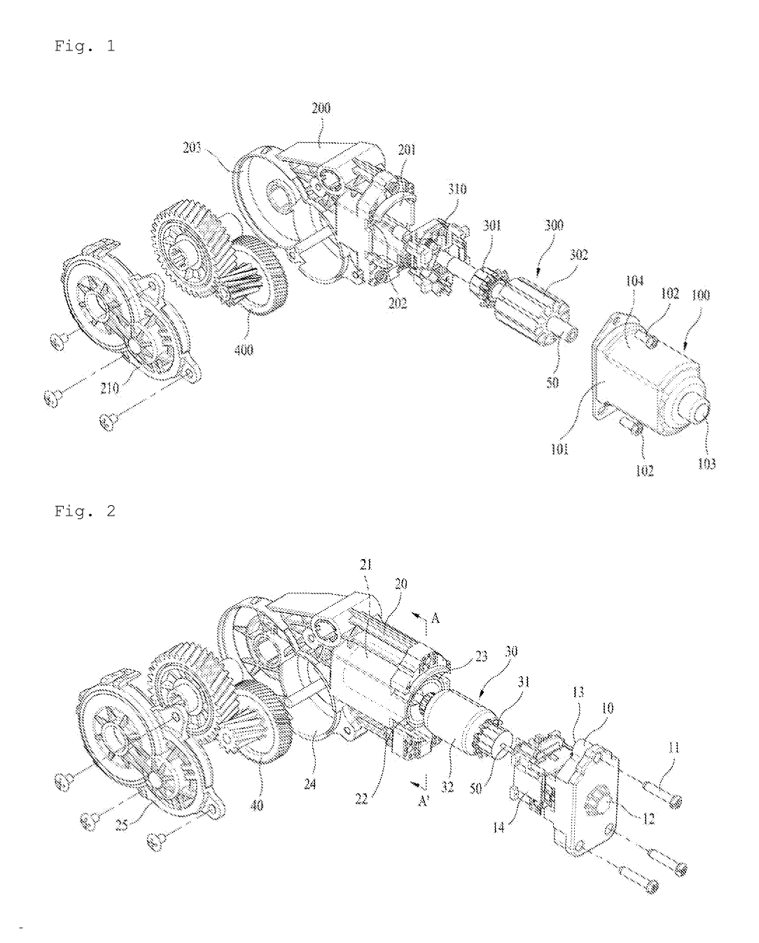

FIG. 2 is an exploded perspective view showing an automobile seat motor according to a first embodiment of the present invention.

As shown in FIG. 2, an automobile seat motor according to the first embodiment of the present invention largely includes a motor housing 20, an end cap 10, an amateur 30 and a gear 40. The motor housing 20 has a first flux ring coupling portion 21 formed in the interior thereof and is coupled at the front side thereof to the end cap 10 by means of bolts 11. The end cap 10 has a motor shaft coupling portion 12 formed at the center of the front side thereof, to which a motor shaft 50 is coupled rotatably. Further, the end cap 10 has a brush holder coupling portion 13 formed at the inside of the rear side thereof. The motor housing 20 and the end cap 10 are made of insulating materials, which are not specially defined thereby, but desirably, they are made through resin molding.

A first flux ring 23 is fixedly inserted into the first flux ring coupling portion 21. The first flux ring 23 is made of a metal material so as to form a magnetic field for activating the rotation of the amateur 30. The first flux ring 23 has a ring magnet 22 coupled to the inside thereof.

According to the first embodiment of the present invention, the first flux ring 23 having the ring magnet 22 coupled to the inside thereof is coupled to the first flux ring coupling portion 21 formed at the inside of the motor housing 20, and the amateur 30 is inserted into the ring magnet 22. On the other hand, the ring magnet 22 has a hollow cylindrical structure. Since the conventional yoke housing is not needed, accordingly, the seat motor according to the first embodiment of the present invention is miniaturized and light, while being easily assembled.

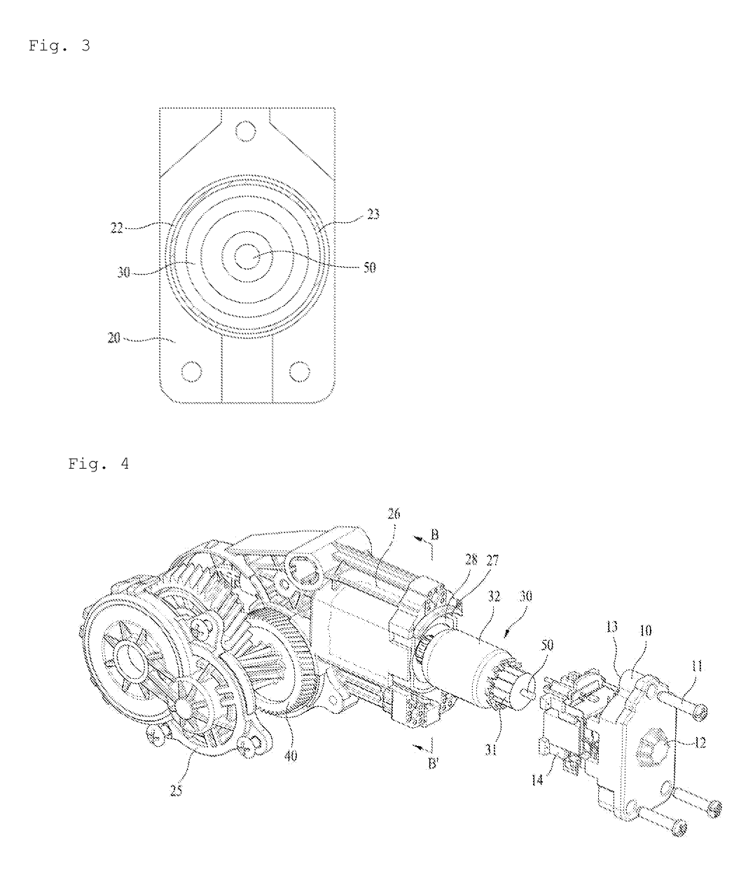

The structure wherein the first flux ring 23 is coupled to the motor housing 20 is shown in FIG. 3. FIG. 3 is a schematic sectional view taken along the direction A-A′ of FIG. 2. As shown, the first flux ring 23 having the ring magnet 22 coupled to the inside thereof is coupled to the inside of the motor housing 20, and the amateur 30 is insertedly located at the inside of the ring magnet 22 in such a manner as to be coupled rotatably to the motor shaft 50.

Referring again to FIG. 2, the amateur 30 has a commutator 31 and a rotor 32 coupled to the motor shaft 50. The commutator 31 is located at the inside of a brush holder 14 disposed at the inside of the end cap 10 and is coupled rotatably to the motor shaft 50. The commutator 31 has repeated electrical contacts with a brush (not shown) located at the inside of the brush holder 14 to cause the magnetic flux to be varied, thereby permitting the rotor 32 to be continuously rotated in one direction.

The motor housing 20 has a gear insertion portion 24 is formed at one side thereof, into which the gear 40 rotated cooperatively together with the motor shaft 50 is inserted. The position of the gear insertion portion 24 and the structure of the gear 40 are freely varied in accordance with the purpose of the seat motor. The structure of the gear 40 of the seat motor as shown in FIG. 2 is applied to the back rest of the power seat.

FIG. 4 is an exploded perspective view showing an automobile seat motor according to a second embodiment of the present invention.

As shown in FIG. 4, the automobile seat motor according to a second embodiment of the present invention has the same structure as that according to the first embodiment of the present invention, except that the first flux ring 23 is replaced with a second flux ring 27 and the ring magnet 22 with a pair of segment magnets 28.

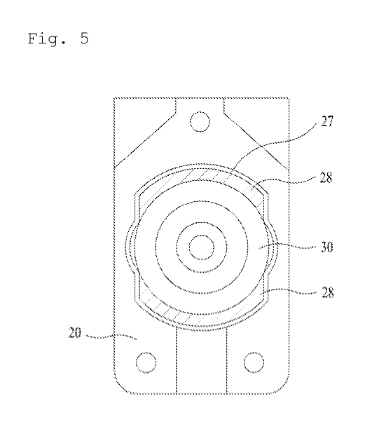

The second flux ring 27 is coupled to a second flux ring coupling portion 26 formed at the inside of the front side of the motor housing 20. The first flux ring 23 has a cylindrical shape, but the second flux ring 27 has a structure where the pair of segment magnets 28 is attached to the inner surfaces of the top and bottom portions thereof. FIG. 5 shows the structure. FIG. 5 is a schematic sectional view taken along the direction B-B′ of FIG. 4, and the second flux ring 27 is coupled to the center of the inside of the motor housing 20. The pair of segment magnets 28 is coupled to the inner surfaces of the top and bottom portions of the second flux ring 27. The amateur 30 is located rotatably at the center of the inside of the second flux ring 27.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An automobile seat motor comprising:
a motor housing having a first flux ring coupling portion formed at the inside of the front side thereof;
a first flux ring coupled to the first flux ring coupling portion and having a ring magnet coupled to the inside thereof;
a motor shaft located at the center of the first flux ring coupling portion in such a manner as to be coupled rotatably to the motor housing; and
a rotor located at the center of the inside of the ring magnet in such a manner as to be rotated together with the motor shaft.

2. The automobile seat motor according to claim 1, further comprising a commutator coupled to the front side of the rotor in such a manner as to be rotated together with the motor shaft.

3. The automobile seat motor according to claim 2, further comprising:
a brush holder into which the front side of the commutator is located; and
an end cap having a brush holder coupling portion to which the brush holder is coupled formed at the inside thereof and a motor shaft coupling portion to which the motor shaft is coupled rotatably.

4. An automobile seat motor comprising:
a motor housing having a second flux ring coupling portion formed at the inside of the front side thereof;
a second flux ring coupled to the second flux ring coupling portion and having a pair of segment magnets coupled to the inner surfaces of the top and bottom portions thereof;
a motor shaft located at the center of the second flux ring coupling portion in such a manner as to be coupled rotatably to the motor housing; and
a rotor located at the center of the inside of the pair of segment magnets in such a manner as to be rotated together with the motor shaft.

5. The automobile seat motor according to claim 4, further comprising a commutator coupled to the front side of the rotor in such a manner as to be rotated together with the motor shaft.

6. The automobile seat motor according to claim 5, further comprising:
a brush holder into which the front side of the commutator is located; and
an end cap having a brush holder coupling portion to which the brush holder is coupled formed at the inside thereof and a motor shaft coupling portion to which the motor shaft is coupled rotatably.
